(19) United States
(12) Patent Application Publication
(10) Pub. No.: US 2011/0010629 A1
(43) Pub. Date: Jan. 13, 2011

(54) SELECTIVELY DISTRIBUTING UPDATES OF CHANGING IMAGES TO CLIENT DEVICES

(75) Inventors: Paul C. Castro, Cambridge, MA (US); Yun-Wu Huang, Hawthorne, NY (US)

Correspondence Address: IBM CORPORATION, T.J. WATSON RESEARCH CENTER, P.O. BOX 218, YORKTOWN HEIGHTS, NY, 10598, US

(73) Assignee: IBM CORPORATION, Yorktown Heights, NY (US)

(21) Appl. No.: 12/500,050

(22) Filed: Jul. 9, 2009

(51) Int. Cl. G06F 3/048; H04W 4/00; G06F 15/16

(52) U.S. Cl. 715/732; 715/753; 709/203; 455/414.3

(57) ABSTRACT

A network server for sharing images with mobile electronic devices having one or more processors, and image sharing client application, and an image distribution application. The image sharing client application is to be executed on one or more of the processors to receive an update to an image being shared over a network with mobile electronic devices that each have their own current zoom level and their own currently visible area of the image. The image distribution application is to be executed on one or more of the processors to keep a record of the current zoom level and currently visible area for each of the plurality of mobile electronic devices and to selectively send image updates to the plurality of mobile electronic devices based on the current zoom level and currently viewable area of the mobile electronic devices.

### FIELD OF THE INVENTION

The present invention relates to sharing changing images over a network with client devices, and in particular to the distribution of dynamic images from a remote network server over a network to client devices.

### BACKGROUND OF THE INVENTION

There has been a great increase in the use of mobile electronic devices (e.g., mobile/cellular/smart phones, Personal Digital Assistants (PDAs), microcomputers, handheld computing and gaming devices and the like). These mobile electronic devices have become increasingly complex. The number and type of applications that these mobile electronic devices support and implement is large and will likely continue to increase. One class of applications involves continuous distribution over a cellular network of full or partial images from an image host to a plurality of mobile client devices that display these images.

In order to promote their mobility, the size of these mobile electronics devices is relatively small compared to conventional laptop and desktop computers, a constraint that also limits the size of their display screen. To operate applications on these mobile electronics devices, the user may rely on image navigation functions, such as zooming and panning, to locate and show details of a certain partial area of a large image. To allow for zoom-in activities by the users, mobile systems may download images in high-resolution.

Mobile device users may view and interact with dynamically changing images provided by a remote server. Examples of this class of applications include and remote desktop applications, in which updates of changing screen images, in full or partial image form, are being dynamically sent from the server to be received and displayed on the client devices. For example, the image may be a slide showing a pie chart that is being played on an image host that is connected to the remote network server. This image may change when the user of the image host moves her cursor to another part of the screen, in which case only part of the image changes, or moves to a new slide, in which case the entire image may change. The image distributed to the mobile device may be said to be dynamic if the image may change over time.

### SUMMARY OF THE INVENTION

Embodiments of the present invention provide a network server for sharing images with mobile electronic devices, the network processor having one or more processors, and image sharing client application, and an image distribution application. The image sharing client application may be executed on one or more of the processors to receive an update to an image being shared over a network with mobile electronic devices that each have their own current zoom level and their own currently visible area of the image. The image distribution application may be executed on one or more of the processors to keep a record of the current zoom level and currently visible area for each of the plurality of mobile electronic devices and to selectively send image updates to the plurality of mobile electronic devices based on the current zoom level and currently viewable area of the mobile electronic devices.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 is a block diagram that illustrates a system for distributing updates of changing images to mobile devices according to embodiments of the present invention.

FIG. 2 is a block diagram of an image host displaying an image, and a mobile communications device displaying part of that image, according to embodiments of the present invention.

FIG. 3 is a block diagram of a network server according to embodiments of the present invention.

FIG. 4 is a block diagram that illustrates an exemplary textual format of the current viewing status data, and the corresponding relative position of a current viewing area and full image, according to embodiments of the present invention.

FIG. 5 is a block diagram that illustrates distribution of images to a client using a combination push-and-pull method according to embodiments of the present invention.

FIG. 6 is a flow chart that illustrates the push method of distributing images to clients according to embodiments of the present invention.

FIG. 7 is a flow chart that illustrates the pull method of distributing images to clients according to embodiments of the present invention.

### DETAILED DESCRIPTION OF PREFERRED EMBODIMENTS

It will be readily understood that the components of the present invention, as generally described and illustrated in the figures herein, may be arranged and designed in a wide variety of different configurations in addition to the described presently preferred embodiments. Thus, the following more detailed description of the embodiments of the present invention, as represented in the figures, is not intended to limit the scope of the invention, as claimed, but is merely representative of selected presently preferred embodiments of the invention. The following description is intended only by way of example, and simply illustrates certain selected presently preferred embodiments of the invention as claimed herein.

Embodiments of the present invention are directed to the distributing of updates of changing images to mobile devices with relatively small screens, such as personal digital assistants or cellular phones. The invention provides a method that allows users of applications on mobile devices to view shared image updates with less network delay for an improved user experience. Embodiments of the invention broadly contemplate improved ways of distributing images to mobile electronic devices, with the images being dynamically distributed from a network server. For convenience, the applications requiring the distribution of changing images to mobile electronic devices are referred to as applications with dynamically changing images. The improvements of this invention is best manifested on changing image applications that distribute high-resolution images (e.g., 1400×1040 pixel resolution) to mobile electronic devices with a relatively small screen size in terms of displayable pixel resolution (e.g., 480×320 pixel resolution).

To view visual details in high resolution from a small mobile device screen, the user may use zooming and panning functions to navigate and locate detail information on the large images. By zooming in, the smaller screen of a mobile client covers only a smaller area of the entire image. By panning around, the area of the image that is currently shown on the display of the mobile client is changed. Therefore, in a system in which a plurality of mobile clients is sharing a high resolution image, each of these mobile clients may display a different area of the image. Since the small screen of a mobile device may at any time cover only a partial portion of the full image shared by the image host, the new updates of the shared image may fall either inside or outside of the area covered by a mobile device's display screen. In embodiments of the invention, only the updates that fall inside a mobile device's display screen are sent to that mobile device. As a result, the size of data transmission to update the mobile device screen can be smaller than that of the approach in which all updates are transmitted to the mobile device. Thus, the user may experience a faster response time in viewing changes to images shared by the remote image host.

Embodiments of the invention provide an application at a network server that receives new images (which can be full images or partial update images) from an image host (such as a remote desktop host computer or a computer whose screen image is to be shared, or their respective proxy servers). According to this embodiment, the network server then determines, for each mobile client, the respective areas within the received new images that are to be sent to each of those mobile clients. In embodiments of the invention, the factor that determines what area within update images is to be sent to a specific mobile client is based on the visible area on the full image that the display screen of the mobile client currently covers.

The zoom level aspect of the invention provides a method for the client to retrieve update images at the resolution that is adequate for the small mobile device screen while improving the update image size, hence reducing the network delay. A higher zoom level is associated with image with a higher resolution. In embodiments of the invention, the client device receives the initial shared image with the viewing area covering the entire image but at the lowest zoom level (i.e., zoom level=0). The client device increases the zoom level when the user of the client device zooms in to view more details of the image. By zooming in, the client device requests the image with a higher resolution but with a smaller view area because the latter contracts within the full image relative to the size of the full image. At any given time, the images transmitted are either lower resolution images covering a larger view area or higher resolution images covering a smaller view area, reducing the need to transmit image data with an excessive size (i.e., high resolution images covering a large view area). For example, the size of the data that represents a typical PowerPoint® slide image may range from approximately 133 Kilobytes (KBs), at a resolution of 1150×860 pixels, to approximately 66 KBs, at a resolution of 720×540 KBs.

In some embodiments, a network gateway server optimizes network load for any given image retrieval, hence allowing the user to view and interact with high-resolution dynamically changing images provided by a remote host in a more fluid manner. A server agent at the network server may keep track of each client device's current zooming level and visible area within an image. An image distribution agent at the server may then update an images on a client device by sending the recent changes of the image that are based on the currently viewable area and the zoom level of the image on the client. In some embodiments, the original high-resolution images are transformed into different levels of resolution because images with less resolution are smaller in size and hence can be transmitted to the devices faster. When the system receives changed image tiles from the image hosts, it may transform them into aforementioned different levels of resolution. Using methods of this disclosure, the mobile client only downloads images with resolution exactly or closely matched to that of it screen, hence eliminating the need to always download high-resolution images which incurs long network delay.

In embodiments, for each client, the system keeps track of its current viewing resolution level and the viewing area (also know as the viewing box) mapped onto the target image of the same resolution level. When the system detects new image changes, it may send to each client only the changes of the same resolution level and that are within the client's viewing box. When the user performs the zooming or panning function, the new parameters containing the latest resolution level and viewing box are sent to the remote network server.

According to these embodiments, the gateway system takes client requests to connect to an image host that provides real-time dynamically changing images (e.g., screen sharing). Upon receiving each dynamic image from the image host, the gateway performs transformation to create corresponding images each with a different level of resolution and maintains a connection to each client allowing for both push and pull function. The push function allows the gateway to push new changes to the clients whereas the pull function allows the client to store its state on the gateway. The status of a client device may be its currently viewing resolution level and the viewing area within the image of the current resolution level. When the gateway receives new image changes from the image hosts, it may perform the push function for each client waiting for the changes. For each waiting client, the gateway may retrieve the latest viewing resolution level and viewing area and only send the changes of the same resolution level that are within the viewing area to the client. If a change image spans across the viewing and non-viewing area for a client, the gateway may clip it so that the part that is within the viewing area is sent.

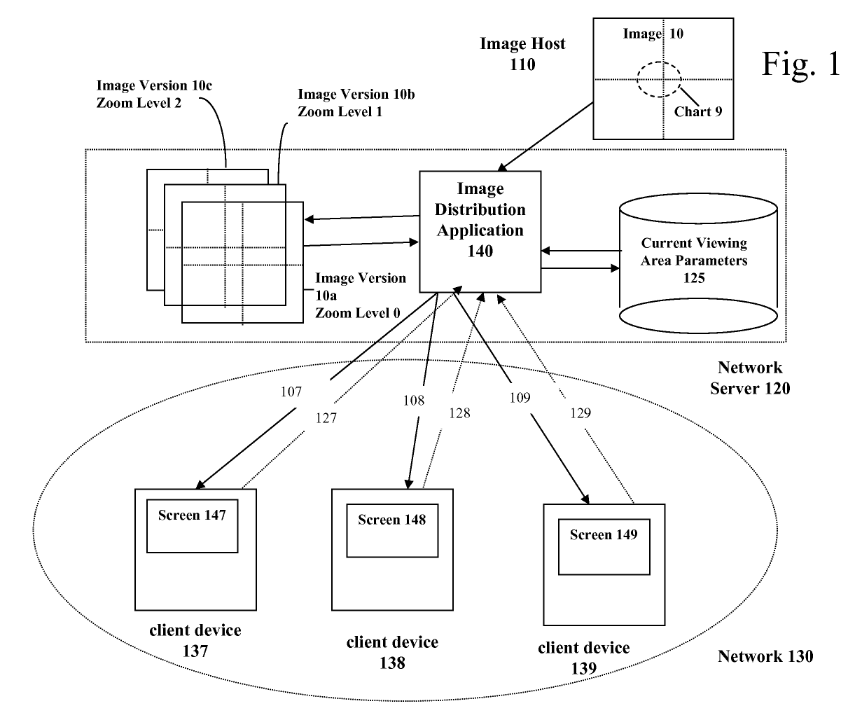

FIG. 1 is a block diagram that illustrates a system for distributing updates of changing images to mobile devices according to embodiments of the present invention. As shown, a network server 120 is coupled to an external image host 110 and to a network 130, which may for example be a cellular communications network, an intranet, the public Internet, or some combination of these. As shown in FIG. 1, network 130 includes a plurality of communication devices 137-139 (which may be mobile electronic devices such as a mobile/cellular/smart phones, PDAs, microcomputers, handheld computing and gaming devices and the like). For example, devices 137-139 may be a BlackBerry® wireless handheld device made by Research In Motion and/or a Palm Treo® smartphone made by Palm, Inc. Network server 120 may be referred to as a gateway server or gateway network server as it separates the image host from the outside network.

Network server 120 may be any type of computing device which manages network resources, such as a personal computer, a workstation, a laptop computer, etc. Image host 1 10 may be any type of computing device that hosts an application that projects images, such as a screen sharing or remote desktop application, in which updates of changing screen images, in full or partial image form, are being dynamically sent from the server to be received and displayed on the clients. Network 130 may be any type of network and may include an intranet, the public Internet, a cellular network, a local area network, a wide area network, a virtual private network, etc. While in some embodiments server 120 connects to external image host 110 through a high-speed network connection, in other embodiments both server 120 of the current invention and an image host 110 may reside in the same computing device. Alternatively, it is also applicable that the image host 110 may communicate with the server 120 of the current invention through a third proxy server.

In the example shown in FIG. 1, image host 110 is displaying an image 10 that contains a chart 9, such as a pie chart that is on a slide of a Lotus® Freelance® or Microsoft® PowerPoint® presentation. For the purposes of illustration, image 10 is shown as divided into four image tiles. More typically, image 10 would be divided into a larger number of tiles, such as 1452 tiles arranged in a grid of 44 by 33. In embodiments of the invention, image host 110 sends image updates to network server 120 when the image 10 being displayed at image host 110 is changed by a user of image host 110, such as a person who is controlling the presentation. The image updates can be in the form of image tiles each of which is a small rectangle or square area of the original full image. The very first full image sent by the image host 110 to the server 120 may be modeled as image updates containing all image tiles of the full image. As would be appreciated by a person of skill in the art, the image may be stored and transmitted as a matrix of pixels or using the Portable Network Graphic (PGN) format or the MPEG-3 or MPEG-4 formats.

As depicted in FIG. 1, the server 120, upon receiving an update images from image host 110, creates and stores multiple image versions 10a , 10b , 10c , each with a different zoom level (0, 1, 2 respectively). These images may be stored in a memory of network server 120 and represent various versions of the image 10 each at a different zoom level. In embodiments of the invention, the image versions 10a-10c that are stored in network server 120 are updated when image host 110 sends server 120 an indication that image 10 was updated. An example of an image update may be a change to a presentation being displayed at the image host device in screen sharing mode. In the embodiment shown, the image 10a with zoom level 0 represent the original image, as updated, received by server 120 from the image host 1 10. The image update 10b with the next zoom level 1 represent update images with resolution that is one notch lower than 10a , whereas the image updates 10c with zoom level 2 represent update images with resolution that is one notch lower than 10b . As an example, zoom level 0 may be at a resolution of 480×320 pixels, level 1 may be at 600×400 pixels, and level 2 may be at 720×480 pixels. The number of zoom levels and the difference of resolution between two adjacent zoom levels may be preconfigured for a specific embodiment of the current invention. In the preferred embodiment of the current invention, the various versions of image updates 10a -10c can be stored in main memory for maximum storing and retrieving efficiency. Alternatively, they can be stored in disks, but the storing and retrieving efficiency will suffer.

As exemplified in FIG. 1, client mobile devices 137-139 may be connected to the server 120 through network 130, which as discussed above may be a cellular network connection. While FIG. 1 shows three example client mobile devices 137-139, the actual number depends on how many client mobile devices have installed the client application and how many of them are connected to the server 120 at any given time. As shown in FIG. 1, each of the mobile devices have a screen 147-149 that may be used to display an image such as image 10.

In the embodiment shown, network server 120 includes an image distribution application 140 which may be a software application that executes on a processor of network server 120. Image distribution application 140 may receive an image from image host 110 that is to be shared with devices 137-139 and may send that image to those devices as network messages 107-109. Image distribution application 140 may then receive an update to that image from image host 110 and may send that image update to those devices, also shown in FIG. 1 as network messages 107-109. In addition, the mobile devices 137-139 may send their current viewing status data to the server 120 as network messages 127-129. The current viewing status data may be contained in an Extensible Markup Language (XML) file. Upon receiving a change to the respective current viewing status data from mobile devices 137-139, the server 120 stores (i.e., records) that for future retrieval as current viewing area parameters 125. When the server 120 receives new image updates from image host 110, server 120 creates multiple versions 10a -10c of the new image updates to reflect the different resolutions may be used by devises sharing the image. Server 120 then, based on the stored current viewing area parameters 125, determines respectively the image updates of the current zoom level of mobile devices 137-139 that are within the current viewing area of these mobile devices. After the appropriate image updates for each mobile client is determined, the server 201 sends them to each mobile client for display.

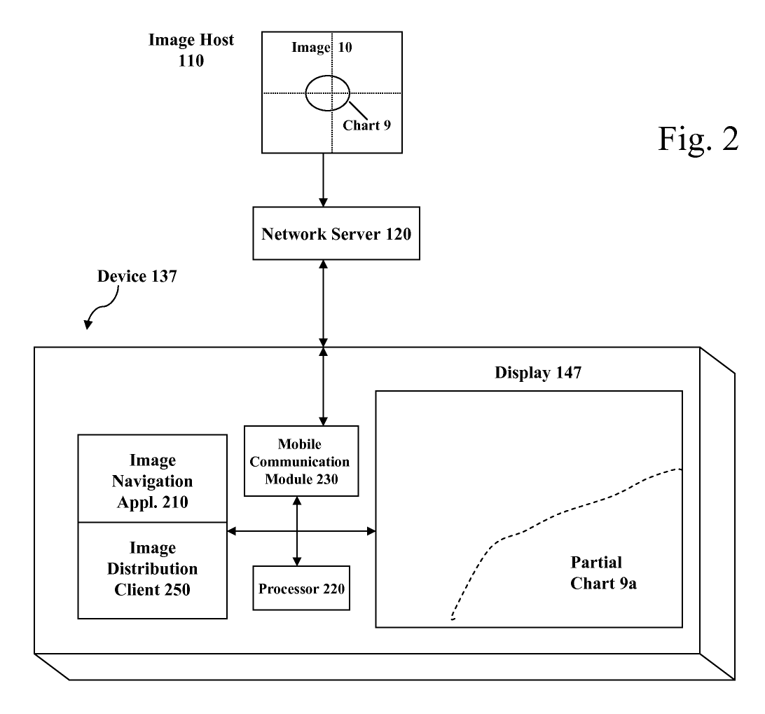

FIG. 2 is a block diagram of an image host displaying an image, and a mobile communications device displaying part of that image, according to embodiments of the present invention. FIG. 2 shows a simplified view of a mobile electronic device 137, such as a mobile/cellular/smart phone and the like, and includes further details of mobile electronic device 137 of FIG. 1. The mobile electronic device 137 comprises structural components, such as those described in FIG. 1, necessary to carry out the functionality as herein described. As is apparent from the description, the present invention is applicable to any appropriately configured electronic device, as described herein.

In the embodiment of FIG. 2, and as discussed with reference to FIG. 1, mobile electronic device 137 may communicate with network server 120, which may in turn communicate with image host 1 10. As also discussed above, image host 110 is shown in FIG. 2 as displaying an image 10 that includes a chart 9. Parts of chart 9 appear in different quadrants, or tiles, of image 10, so that approximately a quarter of chart 9 appears in each of the four quadrants of image 10.

Mobile electronic device 137 of FIG. 2 is shown as including a display 147, a processor 220, a mobile communications module 230, an image navigation application 240, and an image distribution client 250. Processor 220 may be a circuit that processes instructions that drive the operation of device 137, and may be for example a processor that conforms to the ARM 32-bit RISC instruction set architecture (ISA) developed by ARM Limited. Mobile communications module may include software and/or hardware that is used to communicate over a wireless network with a cellular station. Though not shown, device 137 may also include a user interface which may be any of a wide variety of user interfaces, including but not limited to a keypad or keyboard, touch pad, etc. The user interface may also be integrated with the display screen 147, such as with a popular “touch screen” implementation. Communications module 230 facilitates transmission and reception of network communications, such as frequent image updates, as described herein. Accordingly, the mobile electronic device 137 is capable of using an operating system and appropriate hardware components configured for communicating with remote devices via a network connection (e.g. wireless Internet connection) and downloading, displaying, manipulating and modifying pages, as described herein.

Image navigation application 210 may be software that allows a user of device 137 to navigate within an image that is displayed on display 147, such as by panning or zooming. Image navigation application 210 may be part of a general user interface application that allows a user to interface with applications running on device 137. Image distribution client 250 may be software that provides current viewing area parameters for device 137 to network server 120, and in particular to image distribution application 140. For example, when the user of device 137 pans or changes the zoom for the currently displayed image, image distribution client 250 may provide network server 120 with the new current viewing area parameters. In response, network server 120 may store the current viewing area parameters for device 137 in its database and may send the part of the image being panned to, or an image with the desired new resolution, to device 137. Image navigation application 240 and image distribution client 250 may be software that is executed by processor 220.

As shown in FIG. 2, display 147 of mobile electronic device 137 is displaying partial chart 9a . In this example, partial chart 9a is the upper right part of chart 9 that is shown in image 10 at image host 1 10. In this example, the user of device 137 may have been viewing image 10 on display 147 and then may have zoomed in to see details of the image and panned over to the upper corner so that only partial chart 9a is shown on display 147. In addition to the features shown in FIG. 2, mobile electronic device 137 may also include additional elements such as additional processors, memories such as a Read-Only Memory (ROM) and a Random Access Memory (RAM), and one or more busses.

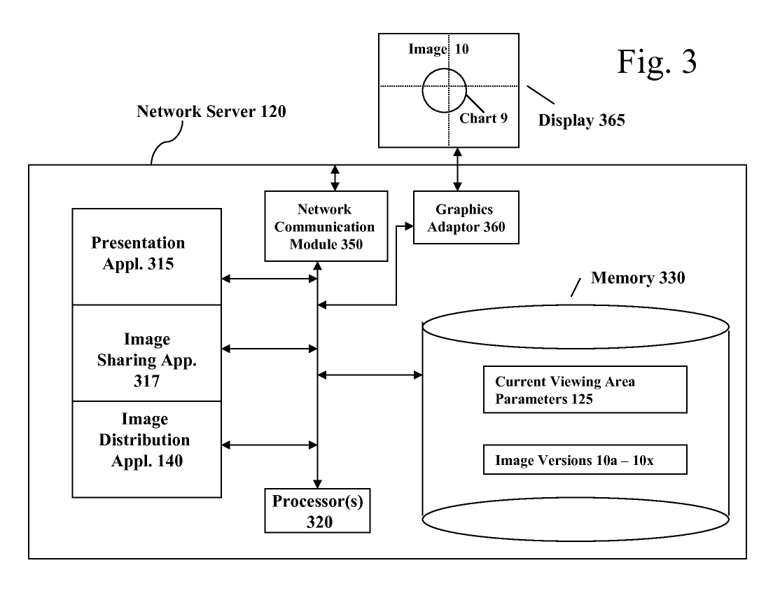

FIG. 3 is a block diagram of a network server according to embodiments of the present invention. In particular, FIG. 3 shows further details of network server 120 of FIG. 1. As shown in FIG. 3, network server 120 contains processor(s) 320, a memory 330, a presentation application 315, an image sharing application 317, an image distribution application 140, a graphics adapter 360, a display 365, and a network communication module 350. System processor(s) 320 may be one or more general-purpose processor(s) and may comprise one of the processors produced by Intel Corporation or by International Business Machines Corporation. Processor(s) 320 may be coupled to a ROM and a system memory (RAM) by a processor bus and may execute application programs under the control of operating system and application software stored in system memory. Network server 120 may also include a number of other devices, including busses, adapters and bridges, such as a network adapter, which may interfaces to a Local Area Network that is in turn coupled to other networks such as a cellular network and/or the Internet. In FIG. 3, network communication module 350 includes software and/or hardware for communications between network server 120 and external networks, such as network 130 of FIG. 1.

Network server 120 may also include a graphics adapter 360 that interfaces network server 120 to display 365. As shown in FIG. 3, display 365 is displaying the image 10 of FIG. 1. Network server 120 may include one or more input ports for communicating with networks such as network 130 and with devices such as image host 110. Network server 120 may also include an input/output (I/O) controller, which controls communication between network server 120 and attached peripheral devices such as a keypad, touch pad, and a disk drive. In addition, an I/O controller may be included that supports external communication by network server 120 via serial and parallel ports.

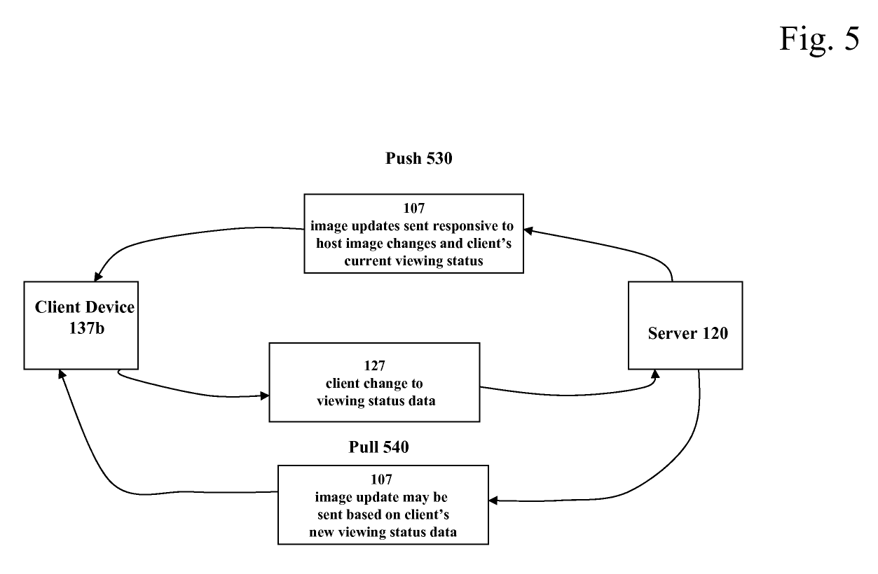

As shown in FIG. 3, memory 330 stores Current Viewing Area Parameters 125 and Image Versions 10a-10x , which are described above with reference to FIG. 1. Memory 330 may be any type of computer readable storage medium such as a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In embodiments, presentation application 315, image sharing application 317, and image distribution application 140 are comprised of software instructions are stored on memory 330 and may be executed by processor(s) 320. Presentation application 315 may be an application, such as Lotus® Freelance® or Microsoft® PowerPoint®, that presents images that may be viewed on a display screen. Image sharing application 317 may be an application, such as Lotus Sametime Unyte™ or Microsoft® NetMeeting®, that allows one user to share that user's screen with other participants in a session so that all the participants in a meeting can view the same presentation on their respective display screens simultaneously. While the embodiment of FIG. 1 has an image host 110 that is external to the network 120, for the purposes of illustration the embodiment shown in FIG. 3 has the image host's functionality (i.e., the functionality of Presentation application 315 and image sharing application 317) are included in the network server. As discussed above, image distribution application 140 may be a software application that receives an image to be shared with remote devices and sends that image to those devices as network messages. Image distribution application 140 may for example carry out the server functionality described with reference to FIGS. 5-7 below.

In a preferred embodiment of the invention, the update images received from the image host represents the highest resolution. Upon receiving image updates, various versions of the updates are created, each with a different resolution represented by a different zoom level. When the user zooms in on an image, the client application increases the zoom level. A higher zoom level is associated with images with higher resolution. For example, when the client first receives the shared image, the viewing area is the entire image while the zoom level is 0 (meaning no zooming in yet). Because the zoom level is 0, the client receives the entire image with the lowest resolution. The lower the resolution of an image, the smaller is the size of the image.

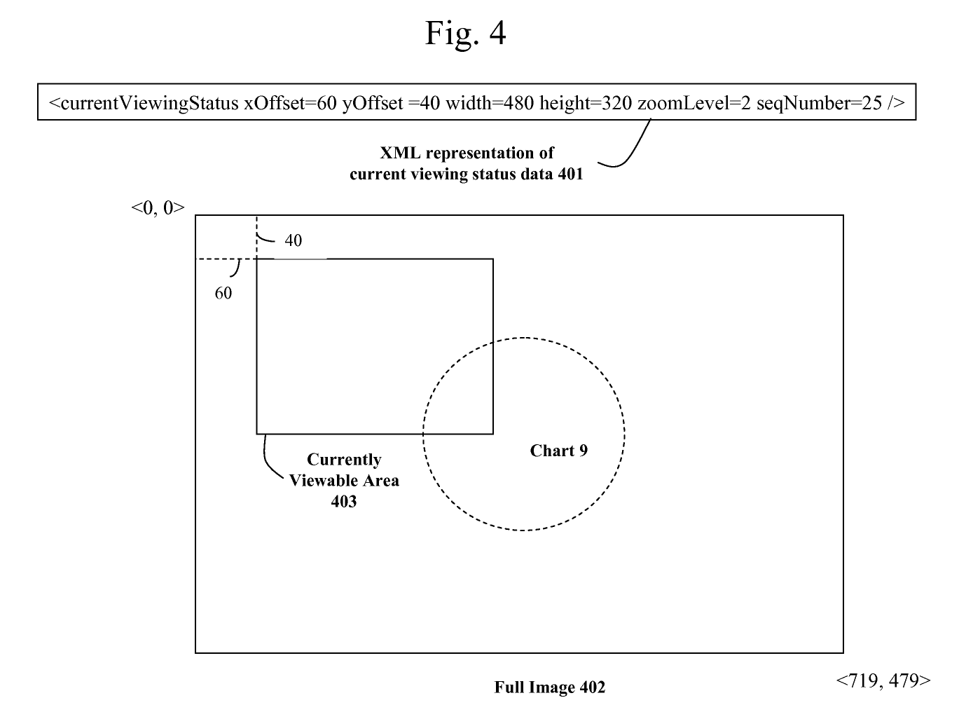

FIG. 4 is a block diagram that illustrates an exemplary textual format of the current viewing status data, and the corresponding relative position of a current viewing area and full image, according to embodiments of the present invention. FIG. 4 shows exemplary current viewing status data 401 in the XML format. While the XML format is shown here, a person of skill in the art would appreciate that other formats may be used, such as JavaScript Object Notation (JSON). As depicted in FIG. 4, the information contained in the current viewing status data 401 includes the currently viewable area modeled by four integers, namely the xOffset=60, yOffset=40, width=480, and height=320. The xOffset and yOffset in the example in FIG. 4 represent x-axis and y-axis pixel offset from the upper left corner of the current viewing area on the full map. The width and height are the width and height of the viewing area in number of pixels. Other information included in the current viewing status data example 401 includes the zoomLevel=2 and the seqNumber=25. The zoomlevel integer represents the current zoom level whereas the seqNumber represents the sequence number used by the network server 120 to determined when the current viewing area at the current zoom level were last updated.

The full image 402 in FIG. 4 shows the resolution (720×480) of the full image at zoom level=2. The rectangle 403 in FIG. 4 depicts the currently viewable area that is modeled inside the XML representation of the current viewing status data 401. If the user performs a panning function, the currently viewable area 403 will move to a different location within 402. If the user performs a zoom in function, the currently viewable area will display images with zoomlevel=3, which has a higher resolution. The currently viewable area 403 contracts in its size relative to the new images with zoomLevel=3. If the user performs a zoom out function, the current view area will display images with zoomLevel=1, which has a lower resolution. The currently viewable area 403 expands in its relative to the new images with zoomlevel=1.

FIG. 5 is a block diagram that illustrates distribution of images to a client using a combination push and pull method according to embodiments of the present invention. As shown in FIG. 5, the push 530 method embodies one feature of the current invention in which the network server 120 dynamically sends image updates 107 (as shown in FIG. 1) to the client device 137 responsive to host image changes and based on the current viewing status data of client device 137. In order for the push method to be functional, the network server 120 typically keeps a live connection with the client device 137. This is because in existing client-server systems, such as in the World Wide Web (WWW) using the HTTP or HTTPS protocols, the server does not keep the network address information of the client and the client does not accept connection requests from other hosts, such as the server. Should the server lose the live connection with the client, the server cannot actively establish another connection with the client. It is up to the client to reconnect to the server to establish a new live connection.

However, in existing open client-server systems such as WWW, a client-server connection cannot be kept alive by the server indefinitely, due to resource constraints, and will expire after a certain amount of time. To remedy this limitation, a preferred embodiment of the current invention that uses WWW open network transportation protocol (i.e., HTTP) can deploy the “long poll” technique to keep the push connection alive. The long poll technique is described, for example, in http://www.perplexedlabs.com/2009.05/04/php-jquery-ajax-javascript-lomg-polling/, a copy of which is herein incorporated by reference. Using the long poll technique, the client opens a Hyper Text Transfer Protocol (HTTP) connection with the server. The server keeps the HTTP connection for a certain amount of time. Right before the HTTP connection expires, if there is no new image updates available for the client, the server sends a response back to the client asking the client to open another HTTP connection again. Thus, other than during the maintenance time when the server responds to ask for a new connection, the server always has a live connection with the client, during which time any new image updates can be pushed to the client. When the client receives new image updates or the open connection response from the server, the client opens a new connection with the server again to establish a new push link.

FIG. 5 also depicts a pull 540 method in which the client device 137 sends its new current viewing status data to the network server 120. Once the new current viewing status data message 127 of FIG. 1 is received by the network server 120, the server may determine that new image updates are available based on the new viewing area and zoom level. In that case, new image updates 107 are then sent from the server to the client. For the pull method, the server needs not maintain a live connection with the client for any extended period of time. Regular HTTP Get or Post method calls can be used to accomplish this task.

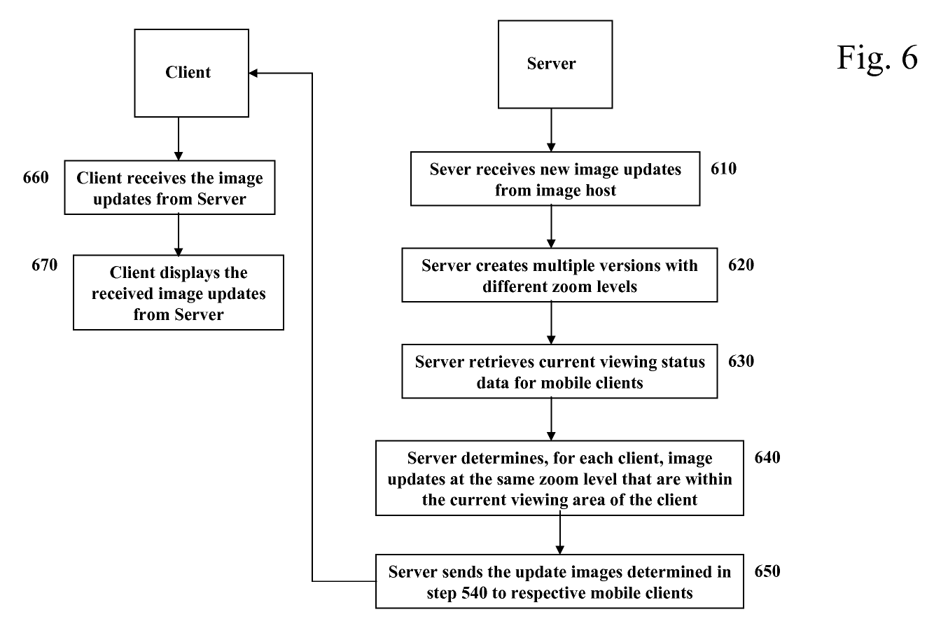

FIG. 6 is a flow chart that illustrates the push method of distributing images to clients according to embodiments of the present invention. As shown in FIG. 6, the server receives new image updates from the image host in step 610. Next, in step 620, the server creates multiple versions of the received image updates with different resolutions each denoted by a unique zoom level. In the next step 630, the server retrieves the current viewing status data for all mobile clients that are connected to the server. Next, in step 640, for each mobile client, the server determines the eligible image updates at the same zoom level as the client's current zoom level, such that only image updates within the client's current viewing area are to be used. For example, the image update might not be sent to a client device if it is determined that the received image update does not indicate a change to the image being displayed in the currently visible area for that client device. The image updates that the sever determines to be appropriate are then sent to the respective clients in step 650. The new image update may be obtained from a version of the image that is stored at the network server and selected based the updated parameter. The update may be sent as fragments of the image (i.e., image tiles), with only those fragments being sent that represent changed parts of the image that are within the current viewing area of the client device. In embodiments, if it is determined that the received image update represents a change to two or more fragments with overlapping areas or adjacent boundaries in the image being displayed in the currently visible viewable area for one of the client devices, then the image update may be sent to the client device as a merged fragment that represents the two or more fragments with overlapping areas or adjacent boundaries. On the client side, upon receiving the new image updates from the server in step 660, the client then displays them accordingly in step 670.

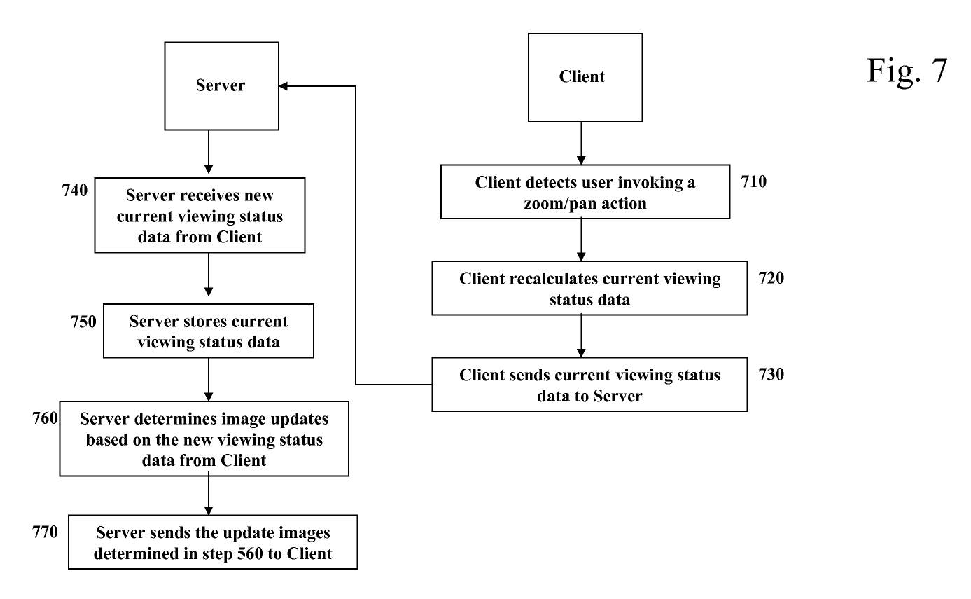

FIG. 7 is a flow chart that illustrates the pull method of distributing images to clients according to embodiments of the present invention. As shown in FIG. 7, the client first detects if the user has invoked a zooming or panning action (step 7 1 0). Upon detecting the zooming or panning action, the client then calculates the new current viewing status data (step 720). A panning action changes the current viewing area but not the zoom level. A zooming action may change both the zoom level and the current viewing area because the xOffset and yOffset (depicted in FIG. 4) may change on the new image with the different zoom level.

After the new current viewing status data is calculated in step 720, the client sends it to the server in step 730. Upon receiving the new current viewing status data sent from a client (step 740), the server updates it in the server's internal repository (step 750). Next, the server determines the eligible image updates at the same zoom level of the newly received current viewing status data, such that the determined image updates includes only the image updates within the client's current viewing area (760). The determined image updates are then sent to the client in step 770.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code (i.e., software) embodied thereon, such as memory 330 shown in FIG. 3.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention provides a method of adaptive distribution and viewing of image updates for dynamically fast changing images sent by a remote image host. Embodiments of the invention detect the latest viewing area status, based on which image updates are filtered such that only image updates within a client's current viewing area are sent to the client. Such filtering helps reduce the size of image objects that are required to transmit to the client in real-time. The invention also creates multiple versions of image updates with various resolutions such that when viewing image covering a large area on a small screen, image updates with low resolution are sent to reduce real-time transmission load without the loss of legibility. Another aspect of the invention provides a method comprising: receiving the information of the current zoom level of each client; receiving from an image host the latest updates of the image shared by the clients; creating various versions of the update images at different respective resolutions, each corresponding to a predefined zoom level; and sending to each client only the portion of the version of updates that is within the current viewing area and of the same current zoom level of the each client.

Reference throughout this specification to “one embodiment” or “an embodiment” (or the like) means that a particular feature, structure, or characteristic described in connection with the embodiment is included in at least one embodiment of the present invention. Thus, appearances of the phrases “in one embodiment” or “in an embodiment” or the like in various places throughout this specification are not necessarily all referring to the same embodiment. Furthermore, the described features, structures, or characteristics may be combined in any suitable manner in one or more embodiments. In the following description, numerous specific details are provided to give a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention. It is to be understood that the invention is not limited to those precise embodiments, and that various other changes and modifications may be affected therein by one skilled in the art without departing from the scope or spirit of the invention.

What is claimed is:

1. A network server for sharing images with mobile electronic devices comprising:
one or more processors;
an image sharing client application to be executed on one or more of the processors to receive an update to an image being shared over a network with a plurality of mobile electronic devices that each have their own current zoom level and their own currently visible area of the image; and
an image distribution application to be executed on one or more of the processors to keep a record of the current zoom level and currently visible area for each of the plurality of mobile electronic devices and to selectively send image updates to the plurality of mobile electronic devices based on the current zoom level and currently viewable area of the mobile electronic devices.

2. The network server of claim 1, wherein the server further comprises a memory to store a plurality of versions of the image, wherein each of these versions has a different resolution level.

3. The network server of claim 2, wherein the memory stores data indicative of the currently visible area and zoom level for each of the plurality of mobile electronic devices.

4. The network server of claim 1, wherein the server further comprises an input port to receive updates to the image from an image host device.

5. The network server of claim 4, wherein the image update is a change to a presentation being displayed at the image host device in screen sharing mode.

6. The network server of claim 1, wherein the network is a cellular telephone network and each of the plurality of client devices is a mobile cellular communications device.

7. A method for sharing images with client devices, the method comprising:
receiving, at a network server, an update of an image being shared with a plurality of client devices that are coupled to the server over a network, wherein each of the client devices has a display that shows a currently viewable area that contains all or a selected part of the image being shared;
determining at the network server, based on recorded parameters of the currently visible area for each of the plurality of client devices, whether the received image update indicates a change to the image being displayed in the currently visible area for each of the plurality of client devices; and
sending the image update selectively to one or more of the client devices based on the results of the determination.

8. The method of claim 7, wherein the image update is not sent to a client device if it is determined that the received image update does not indicate a change to the image being displayed in the currently visible area for that client device.

9. The method of claim 7, wherein the image being shared with the plurality of client devices is comprised of a plurality of fragments, and wherein if it is determined that the received image update represents a change to two or more fragments with overlapping areas or adjacent boundaries in the image being displayed in the currently visible area for one of the client devices, then the image update is sent to the client device as a merged fragment that represents the two or more fragments with overlapping areas or adjacent boundaries.

10. The method of claim 7, further comprising the steps of:
receiving at the network server an update from a client device to a parameter of the currently visible area for that client device;
storing the received parameter update at the network server; and
sending a new image update to that client device based on the updated parameter.

11. The method of claim 8, wherein the new image update is obtained from a version of the image that is stored at the network server and selected based the updated parameter.

12. The method of claim 7, wherein the network server stores parameters of the currently visible area for each of the plurality of client devices that include the resolution level for the client device and an identification of the part of the image that is visible at the client device.

13. The method of claim 7, wherein the step of sending image updates from the server to the client devices is based on the long polling technique.

14. A method for processing a shared image on a mobile electronic device comprising:
displaying on a screen of a mobile electronic device an image received from a network server over a network, wherein the image displayed at the mobile electronic device represents the currently visible area of an image maintained at the network server;
receiving a change from a user of the mobile electronic device to one or more parameters of the visible area for the mobile electronic device; and
sending an update to the network server of the current parameters of the currently visible area for the mobile electronic device.

15. The method of claim 14, further comprising receiving an image update from the network server over the network, wherein the image update corresponds to the change to the currently visible area of the mobile electronic device.

16. The method of claim 14, wherein the change to the currently visible area that is received from the user is one of a zoom into the displayed image or a pan to a part of the image maintained at the network server that is different than the image currently displayed at the mobile electronic device.

17. A computer program product for sharing images with mobile electronic devices, the computer program product comprising:
a computer readable storage medium having computer readable program code embodied therewith, the computer readable program code comprising:
computer readable program code configured to keep a record of the current resolution level and currently visible area of a plurality of client mobile electronic devices that are sharing an image;
computer readable program code configured to detect a change to the shared image and, in response, to send to each client mobile electronic device only the changes of the same resolution level and that are within the client electronic device's currently visible area; and
computer readable program code configured to receive parameters containing a new current resolution level or currently visible area from a client mobile electronic device.

18. The computer program product of claim 17, wherein the computer readable program code further comprises computer readable program code to determine, based on the received parameters containing a new current resolution level or currently visible area for a client mobile electronic device, that an image update should be sent to the client device and to send that image update to the client device.

19. The computer program product of claim 17, wherein the computer readable program code further comprises computer readable program code to only send changes to the client mobile electronic devices that are of the same current resolution level as the client mobile electronic device and that are within the currently visible area of the client mobile electronic device.

20. The computer program product of claim 17, wherein the computer readable program code further comprises computer readable program code to determine if a changed image spans across the currently visible area and non-viewing area for a client and, if so, to clip the image so that only part of the image within the currently visible area is sent to the client mobile electronic device.
